(19) United States
(12) Patent Application Publication
(10) Pub. No.: US 2020/0057576 A1
(43) Pub. Date: Feb. 20, 2020

(54) METHOD AND SYSTEM FOR INPUT/OUTPUT PROCESSING FOR WRITE THROUGH TO ENABLE HARDWARE ACCELERATION

(71) Applicant: AVAGO TECHNOLOGIES GENERAL IP (SINGAPORE) PTE. LTD., Singapore (SG)

(72) Inventors: Horia Simionescu, Foster City, CA (US); Timothy Hoglund, Colorado Springs, CO (US); Sridhar Rao Veerla, Bangalore (IN); Panthini Pandit, Bangalore (IN); Gowrisankar Radhakrishnan, Colorado Springs, CO (US)

(21) Appl. No.: 16/103,994

(22) Filed: Aug. 16, 2018

(51) Int. Cl. G06F 3/06; G06F 12/0866

(52) U.S. Cl. CPC G06F 3/0655; G06F 3/0689; G06F 2212/206; G06F 12/0866; G06F 2212/262; G06F 3/061

(57) ABSTRACT

A system and method for efficient write through processing of Input/Output (I/O) requests are provided. One example of the illustrative method includes receiving a first write request to a first row, while processing the first write request, receiving a subsequent write request to the first row, and then caching the subsequent write request for processing until the first write request is completed.

### FIELD OF THE DISCLOSURE

The present disclosure is generally directed toward computer memory.

### BACKGROUND

On RAID 0/1 write through volumes, data corresponding to a write request need not be buffered. Rather, the data can be written directly to the drives. But since a RAID 5/6 volume also has one or more parity drives which requires an update with every write, the data needs to be buffered temporarily before writing to the drives, thereby ensuring that new parity can be generated.

Traditional algorithms need to take region locks to ensure that no more than one Input/Output (I/O) request is allowed on a row at the same time since any write within the row also involves updating the parity. While writes to the drives need to serialize, other operations such as allocating buffers, transferring data from a host to internal buffers, stitching the buffers into cache segments, etc. can go in parallel for multiple commands even on the same row. Unfortunately, current memory systems to do accommodate such processes.

### BRIEF DESCRIPTION OF THE DRAWINGS

The present disclosure is described in conjunction with the appended figures, which are not necessarily drawn to scale:

FIG. 1 is a block diagram depicting a computing system in accordance with at least some embodiments of the present disclosure;

FIG. 2A is a block diagram depicting details of an illustrative controller in accordance with at least some embodiments of the present disclosure;

FIG. 2B is a block diagram depicting additional details of an illustrative controller and processing flows between components thereof in accordance with at least some embodiments of the present disclosure;

FIG. 3 is a block diagram depicting details of a first data structure used in accordance with at least some embodiments of the present disclosure;

FIG. 4 is a block diagram depicting details of a second data structure used in accordance with at least some embodiments of the present disclosure;

FIG. 5 is a block diagram depicting details of a third data structure used in accordance with at least some embodiments of the present disclosure;

FIG. 6 is a block diagram depicting details of a fourth data structure used in accordance with at least some embodiments of the present disclosure;

FIG. 7 is a flow diagram depicting a method of write through write command processing in accordance with at least some embodiments of the present disclosure;

FIG. 8 is a flow diagram depicting a method of allocating write buffers in accordance with at least some embodiments of the present disclosure;

FIG. 9A is a first portion of a flow diagram depicting a method of performing a write through cache buffering process in accordance with at least some embodiments of the present disclosure;

FIG. 9B is a second portion of a flow diagram depicting a method of performing a write through cache buffering process in accordance with at least some embodiments of the present disclosure;

FIG. 9C is a third portion of a flow diagram depicting a method of performing a write through cache buffering process in accordance with at least some embodiments of the present disclosure;

FIG. 9D is a fourth portion of a flow diagram depicting a method of performing a write through cache buffering process in accordance with at least some embodiments of the present disclosure;

FIG. 10 is a flow diagram depicting a method of updating buffers in accordance with at least some embodiments of the present disclosure;

FIG. 11 is a flow diagram depicting a method of performing a cache update in accordance with at least some embodiments of the present disclosure;

FIG. 12 is a flow diagram depicting a method of processing a cache segment in accordance with at least some embodiments of the present disclosure; and

FIG. 13 is a flow diagram depicting a method of checking and releasing a cache segment in accordance with at least some embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is being understood that various changes may be made in the function and arrangement of elements without departing from the spirit and scope of the appended claims.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

As will be discussed in further detail herein, the present disclosure proposes a solution which replaces current firmware-driven implementations with hardware managed flows (both control and data paths), using optimizations for hardware I/O processing. The proposed method, in some embodiments, provides an optimized I/O processing mechanism to avoid region locks for RAID 5/6 write through I/O processing without compromising on the data integrity.

Another aspect of the present disclosure is to provide a method to queue the host's write requests for a row when previous write requests are undergoing a flush process (or similar process).

Another aspect of the present disclosure is to allow implicit coalescing of all write I/Os that are received when a flush is already active on a row in the context of previous write processing. This effectively ensures that write I/Os can be optimally processed without undue delay.

Although embodiments of the present disclosure will be described in connection with managing a RAID architecture (e.g., a RAID-5 or RAID-6 type of architecture), it should be appreciated that embodiments of the present disclosure are not so limited. In particular, any controller that finds benefits associated with buffer allocation strategies and/or hardware acceleration can implement some or all of the functions and features described herein.

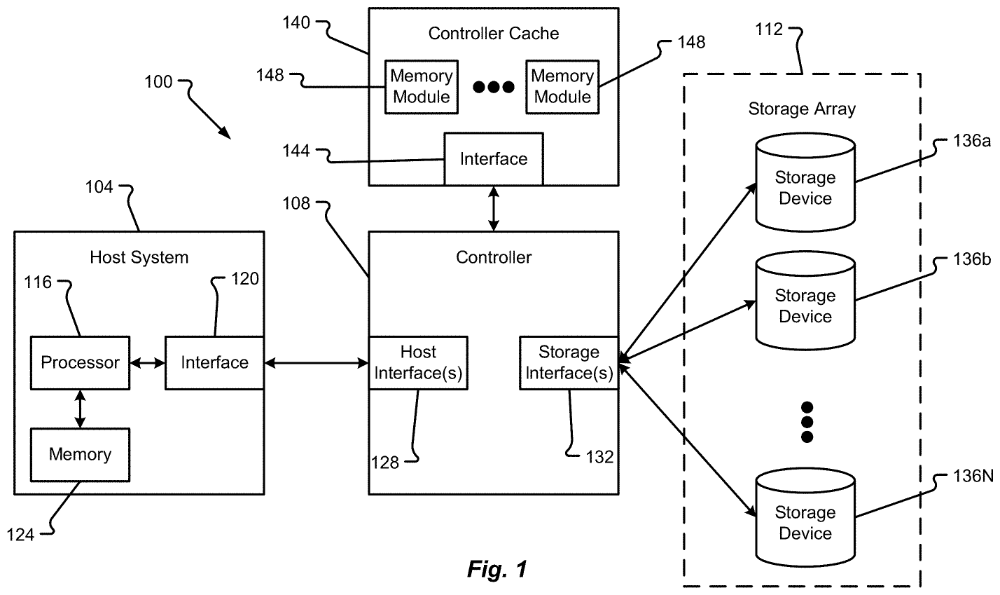

With reference to FIGS. 1-13, various embodiments of the present disclosure will be described. While many of the examples depicted and described herein will relate to RAID architecture, it should be appreciated that embodiments of the present disclosure are not so limited. Indeed, aspects of the present disclosure can be used in any type of computing system and/or memory environment. In particular, embodiments of the present disclosure can be used in any type of caching scheme (whether employed by a RAID controller or some other type of device used in a communication system). In particular, solid state drives, hard drives, solid state/hard drive controllers (e.g., SCSI controllers, SAS controllers, or RAID controllers) may be configured to implement embodiments of the present disclosure. As another example, network cards or the like having cache memory may also be configured to implement embodiments of the present disclosure.

With reference now to FIG. 1, additional details of a computing system 100 capable of implementing hashing methods and various cache lookup techniques will be described in accordance with at least some embodiments of the present disclosure. The computing system 100 is shown to include a host system 104, a controller 108 (e.g., a SCSI controller, a SAS controller, a RAID controller, etc.), and a storage array 112 having a plurality of storage devices 136a-N therein. The system 100 may utilize any type of data storage architecture. The particular architecture depicted and described herein (e.g., a RAID architecture) should not be construed as limiting embodiments of the present disclosure. If implemented as a RAID architecture, however, it should be appreciated that any type of RAID scheme may be employed (e.g., RAID-0, RAID-1, RAID-2, . . . , RAID-5, RAID-6, etc.).

In a RAID-0 (also referred to as a RAID level 0) scheme, data blocks are stored in order across one or more of the storage devices 136a-N without redundancy. This effectively means that none of the data blocks are copies of another data block and there is no parity block to recover from failure of a storage device 136. A RAID-1 (also referred to as a RAID level 1) scheme, on the other hand, uses one or more of the storage devices 136a-N to store a data block and an equal number of additional mirror devices for storing copies of a stored data block. Higher level RAID schemes can further segment the data into bits, bytes, or blocks for storage across multiple storage devices 136a-N. One or more of the storage devices 136a-N may also be used to store error correction or parity information.

A single unit of storage can be spread across multiple devices 136a-N and such a unit of storage may be referred to as a stripe. A stripe, as used herein and as is well known in the data storage arts, may include the related data written to multiple devices 136a-N as well as the parity information written to a parity storage device 136a-N. In a RAID-5 (also referred to as a RAID level 5) scheme, the data being stored is segmented into blocks for storage across multiple devices 136a-N with a single parity block for each stripe distributed in a particular configuration across the multiple devices 136a-N. This scheme can be compared to a RAID-6 (also referred to as a RAID level 6) scheme in which dual parity blocks are determined for a stripe and are distributed across each of the multiple devices 136a-N in the array 112.

One of the functions of the controller 108 is to make the multiple storage devices 136a-N in the array 112 appear to a host system 104 as a single high capacity disk drive. Thus, the controller 108 may be configured to automatically distribute data supplied from the host system 104 across the multiple storage devices 136a-N (potentially with parity information) without ever exposing the manner in which the data is actually distributed to the host system 104.

In the depicted embodiment, the host system 104 is shown to include a processor 116, an interface 120, and memory 124. It should be appreciated that the host system 104 may include additional components without departing from the scope of the present disclosure. The host system 104, in some embodiments, corresponds to a user computer, laptop, workstation, server, collection of servers, or the like. Thus, the host system 104 may or may not be designed to receive input directly from a human user.

The processor 116 of the host system 104 may include a microprocessor, central processing unit (CPU), collection of microprocessors, or the like. The memory 124 may be designed to store instructions that enable functionality of the host system 104 when executed by the processor 116. The memory 124 may also store data that is eventually written by the host system 104 to the storage array 112. Further still, the memory 124 may be used to store data that is retrieved from the storage array 112. Illustrative memory 124 devices may include, without limitation, volatile or non-volatile computer memory (e.g., flash memory, RAM, DRAM, ROM, EEPROM, etc.).

The interface 120 of the host system 104 enables the host system 104 to communicate with the controller 108 via a host interface 128 of the controller 108. In some embodiments, the interface 120 and host interface(s) 128 may be of a same or similar type (e.g., utilize a common protocol, a common communication medium, etc.) such that commands issued by the host system 104 are receivable at the controller 108 and data retrieved by the controller 108 is transmittable back to the host system 104. The interfaces 120, 128 may correspond to parallel or serial computer interfaces that utilize wired or wireless communication channels. The interfaces 120, 128 may include hardware that enables such wired or wireless communications. The communication protocol used between the host system 104 and the controller 108 may correspond to any type of known host/memory control protocol. Non-limiting examples of protocols that may be used between interfaces 120, 128 include SAS, SATA, SCSI, FibreChannel (FC), iSCSI, ATA over Ethernet, InfiniBand, or the like.

The controller 108 may provide the ability to represent the entire storage array 112 to the host system 104 as a single high volume data storage device. Any known mechanism can be used to accomplish this task. The controller 108 may help to manager the storage devices 136a-N (which can be hard disk drives, sold-state drives, or combinations thereof) so as to operate as a logical unit. In some embodiments, the controller 108 may be physically incorporated into the host device 104 as a Peripheral Component Interconnect (PCI) expansion (e.g., PCI express (PCI)e) card or the like. In such situations, the controller 108 may be referred to as a RAID adapter.

The storage devices 136a-N in the storage array 112 may be of similar types or may be of different types without departing from the scope of the present disclosure. The storage devices 136a-N may be co-located with one another or may be physically located in different geographical locations. The nature of the storage interface 132 may depend upon the types of storage devices 136a-N used in the storage array 112 and the desired capabilities of the array 112. The storage interface 132 may correspond to a virtual interface or an actual interface. As with the other interfaces described herein, the storage interface 132 may include serial or parallel interface technologies. Examples of the storage interface 132 include, without limitation, SAS, SATA, SCSI, FC, iSCSI, ATA over Ethernet, InfiniBand, or the like.

The controller 108 is shown to have communication capabilities with a controller cache 140. While depicted as being separate from the controller 108, it should be appreciated that the controller cache 140 may be integral to the controller 108, meaning that components of the controller 108 and the controller cache 140 may be contained within a single physical housing or computing unit (e.g., server blade). The controller cache 140 is provided to enable the controller 108 to perform caching operations. The controller 108 may employ caching operations during execution of I/O commands received from the host system 104. Depending upon the nature of the I/O command and the amount of information being processed during the command, the controller 108 may require a large number of cache memory modules 148 (also referred to as cache memory) or a smaller number of cache memory modules 148. The memory modules 148 may correspond to flash memory, RAM, DRAM, DDR memory, or some other type of computer memory that is quickly accessible and can be rewritten multiple times. The number of separate memory modules 148 in the controller cache 140 is typically larger than one, although a controller cache 140 may be configured to operate with a single memory module 148 if desired.

The cache interface 144 may correspond to any interconnect that enables the controller 108 to access the memory modules 148, temporarily store data thereon, and/or retrieve data stored thereon in connection with performing an I/O command or some other executable command. In some embodiments, the controller cache 140 may be integrated with the controller 108 and may be executed on a CPU chip or placed on a separate chip within the controller 108. In such a scenario, the interface 144 may correspond to a separate bus interconnect within the CPU or traces connecting a chip of the controller cache 140 with a chip executing the processor of the controller 108. In other embodiments, the controller cache 140 may be external to the controller 108 in which case the interface 144 may correspond to a serial or parallel data port.

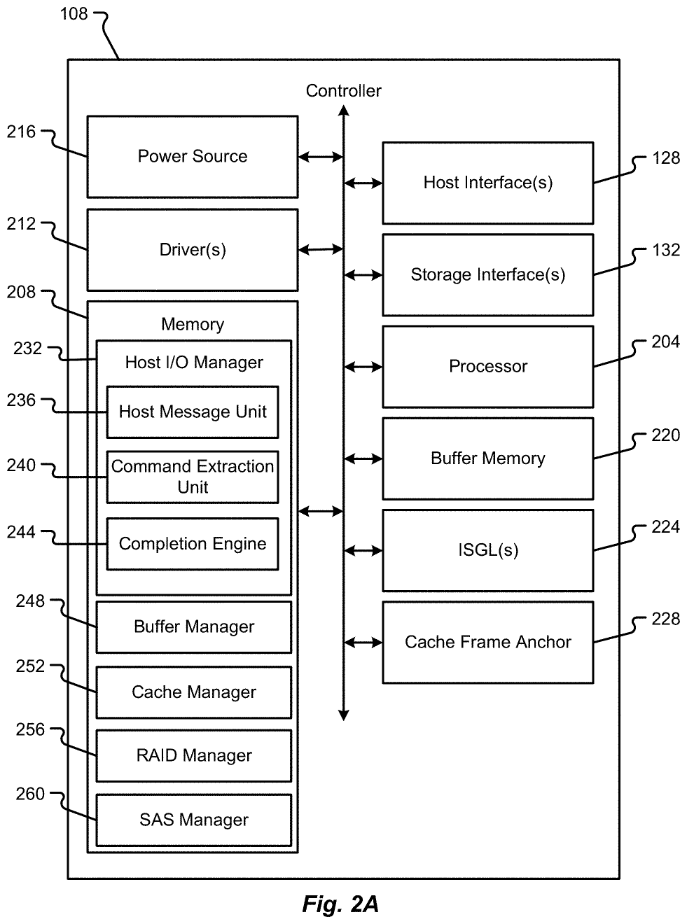

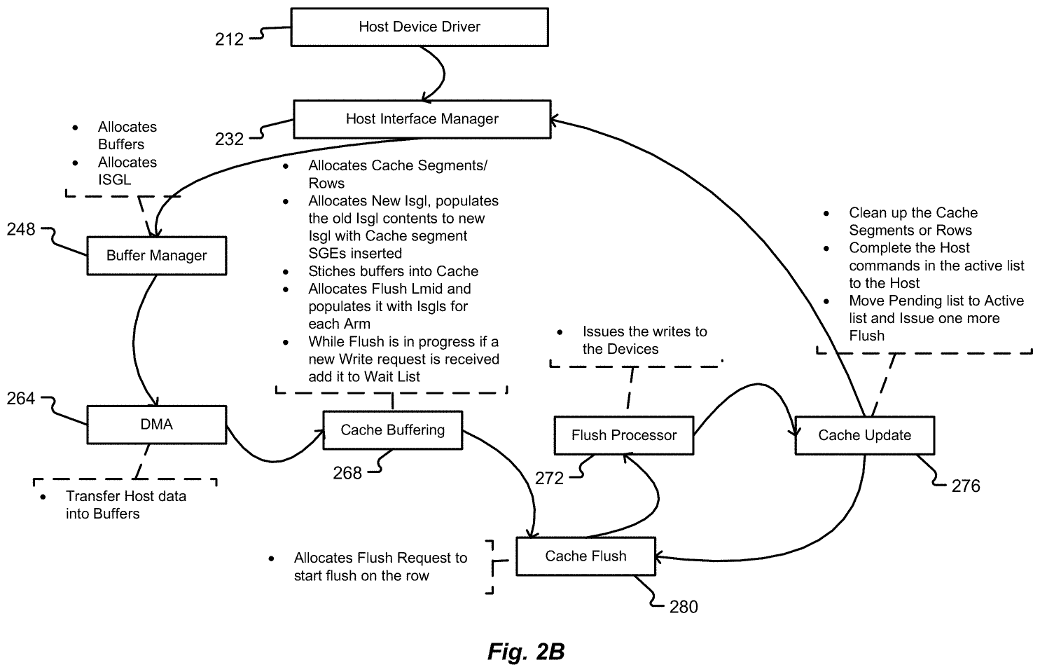

With reference now to FIGS. 2A and 2B additional details of a controller 108 will be described in accordance with at least some embodiments of the present disclosure. The controller 108 as depicted in FIG. 2A is shown to include the host interface(s) 128 and storage interface(s) 132. The controller 108 is also shown to include a processor 204, memory 208 (e.g., a main controller memory), one or more drivers 212, and a power source 216.

The processor 204 may include an Integrated Circuit (IC) chip or multiple IC chips, a CPU, a microprocessor, or the like. The processor 204 may be configured to execute instructions in memory 208 that are shown to include a host I/O manager 232, a buffer manager 248, a cache manager 252, a RAID manager 256, and a SAS manager 260. Furthermore, in connection with performing caching or buffer functions, the processor 204 may utilize buffer memory 220, one or more Internal Scatter Gather Lists (ISGLs) 224, and a cache frame anchor 228. The host I/O manager 232 is shown to include a plurality of sub-routines that include, without limitation, a host message unit 236, a command extraction unit 240, and a completion engine 244.

Each of the components (e.g., host I/O manager 232, buffer manager 248, cache manager 252, RAID manager 256, and SAS manager 260) may correspond to different functional blocks that operate in their own local memory loading the global memory (e.g. a global buffer memory 220 or memory 208) on an as-needed basis. Each of these different functional blocks can be accelerated by different hardware threads without departing from the scope of the present disclosure.

The memory 208 may be volatile and/or non-volatile in nature. As indicated above, the memory 208 may include any hardware component or collection of hardware components that are capable of storing instructions and communicating those instructions to the processor 204 for execution. Non-limiting examples of memory 208 include RAM, ROM, flash memory, EEPROM, variants thereof, combinations thereof, and the like. Similarly, the buffer memory 220 may be volatile or non-volatile in nature. The buffer memory may be configured for multiple read/writes and may be adapted for quick access by the processor 204.

The instructions stored in memory 208 are shown to be different instruction sets, but it should be appreciated that the instructions can be combined into a smaller number of instruction sets without departing from the scope of the present disclosure. The host I/O manager 232, when executed, enable the processor 204 to manage I/O commands received from the host system 104 and facilitate higher-level communications with the host system 104. In some embodiments, the host I/O manager 232 may utilize the host message unit 236 to process incoming messages received from the host system 104. As a non-limiting example, the controller 108 may receive messages from the host system 104 in an MPI protocol. The host message unit 236 may bring down the messages received from the host system 104 and pass the content of the messages to the command extraction unit 240. The command extraction unit 240 may be configured to determine if a particular command in a message is acceleratable (e.g., capable of being passed to a particular functional block to facilitate hardware acceleration). If a command is determined to be acceleratable, then the command extraction unit 240 may implement a hardware acceleration process and generate an appropriate Local Message ID (LMID) that represents all of the information received from the host system 104 (in the command). The LMID effectively represents the command received from the host system 104, but is in a different format that is understandable by the managers 248, 252, 256, 260. The command extraction unit 240 may, in some embodiments, route the various commands (e.g., LMIDs) to one or more of the buffer manager 248, cache manager 252, RAID manager 256, and SAS manager 260. The routing of the commands may depend upon a type of the command and the function to be executed. The completion engine of the host I/O manager 232 may be responsible for reporting to the host system 104 that an I/O command has been completed by the controller 108.

The buffer manager 248 may include instructions that, when executed, enable the processor 204 to perform various buffer functions. As an example, the buffer manager 248 may enable the processor 204 to recognize a write command and utilize the buffer memory 220 in connection with executing the write command. In some embodiments, any command or function that leverages the buffer memory 220 may utilize the buffer manager 248.

The cache manager 252 may include instructions that, when executed, enable the processor 204 to perform various caching functions. The cache manager 252 may enable the processor 204 to communicate with the controller cache 140 and leverage the memory modules 148 of the controller cache 140. The cache manager 252 may also manage the creation and lifecycle of cache frame anchors 228 and/or ISGLs 224. As an example, as caching functions are executed, one or more cache frame anchors 228 may be created or utilized to facilitate the caching function. As used herein, an ISGL may represent the snapshot of data at a given point in time it is used. In some embodiments, the ISGL is capable of encapsulating all the metadata that is required for an I/O request (e.g. read request, write request, etc.), thereby providing an efficient communication mechanism between various modules for processing the read/write and/or read-ahead operations.

The RAID manager 256 and/or SAS manager 260 may include instructions that, when executed, enable the processor 204 to communicate with the storage array 112 or storage devices 136 therein. In some embodiments, the RAID manager 256 and/or SAS manager 260 may receive commands either directly from the host I/O manager 232 (if no caching was needed) or they may receive commands from the cache manager 252 after an appropriate caching process has been performed. When invoked, the RAID manager 256 and/or SAS manager 260 may enable the processor 204 to finalize read or write commands and exchange data with the storage array 112. Other functions enabled by the RAID manager 256 and/or SAS manager 260 will be described in further detail herein.

The driver(s) 212 may comprise firmware, hardware, software, or combinations thereof that enable the processor 204 to make use of other hardware components in the controller 108. For instance, different drivers 212 may be provided to support functions of the interfaces 128, 132. As another example, separate drivers 212 may be provided to support functions of the buffer memory 220. The drivers 212 may perform the low-level routines that allow the processor 204 to communicate with the other hardware components and respond to commands received from the processor 204.

The power source 216 may correspond to hardware components that provide the controller 108 with the power necessary to run the processor 204 and other components. As an example, the power source 216 may correspond to a power converter that receives AC power from an external source (e.g., a power outlet) and converts the AC power into DC power that is useable by the other hardware components of the controller 108. Alternatively or additionally, the power source 216 may correspond to an internal power source (e.g., a battery pack, bank of capacitors, etc.) that provides power to the hardware components of the controller 108.

FIG. 2B depicts additional details of the controller 108 and components thereof. Specifically, FIG. 2B shows interactions between a host device driver 212 of the controller 108, the host interface manager 232, the buffer manager 248, a DMA engine 264, a cache buffering routine 268, a flush processor 272, a cache update routine 276, and a cache flush routine 280. As shown in FIG. 2A, an I/O request may be received at the host interface manager 232 from the host device driver 212. The host interface manager 232 may forward the I/O request or components thereof to the buffer manager 248.

The buffer manager 248 allocates one or more buffers from buffer memory 220 and allocates one or more ISGL(s) 224. The buffer manager 248 then leverages the DMA engine 264 to effect the transfer of host data into the allocated buffer(s). Thereafter, the cache buffering routine 268 is invoked (e.g., by transmitting an LMID to the cache manager 252 from the DMA manager 264). More specifically, the cache buffering routine 268, cache update routine 276, and cache flush routine 280 may all be routines executed within the cache manager 252. Thus, when the cache buffering routine 268 is invoked, the cache manager 252 may allocate an appropriate number of cache segments (CSs) or rows. The cache buffering routine 268 may further allocate new ISGL(s), populate the old ISGL(s) with contents that point to the new ISGL(s) with cache segment Scatter Gather Elements (SGEs) inserted. The cache buffering routine 268 may then stitch buffers into the cache and allocate a flush LMID and populate the flush LMID with ISGLs for each arm. While the cache flush is in progress, if a new write request is received at the host device driver 212, the cache buffering routine 268 will add it to a wait list as will be described in further detail herein.

The cache buffering routine 268 then forwards the flush request to cache flush 280. Cache flush 280 will further forward it to the flush processor 272. The flush processor 272 is then configured to generate the parity data and issue writes to the appropriate memory devices in the storage array 112. After the writes are done the flush processor 272 would forward the request to cache update routine 276. The cache update routine 276 is then used to clean up the CSs or rows and complete the host commands in the active list to the host. The cache update routine 276 then moves the pending list if not empty to the active list and issues one more flush command for the cache flush routine 280. The cache flush routine 280 allocates the flush request to start the flush on the row and then reverts back to the flush processor 272. If no additional writes are pending, the cache update routine 276 notifies the host interface manager 232 to inform the host that the requested I/O commands in the active list have been completed.

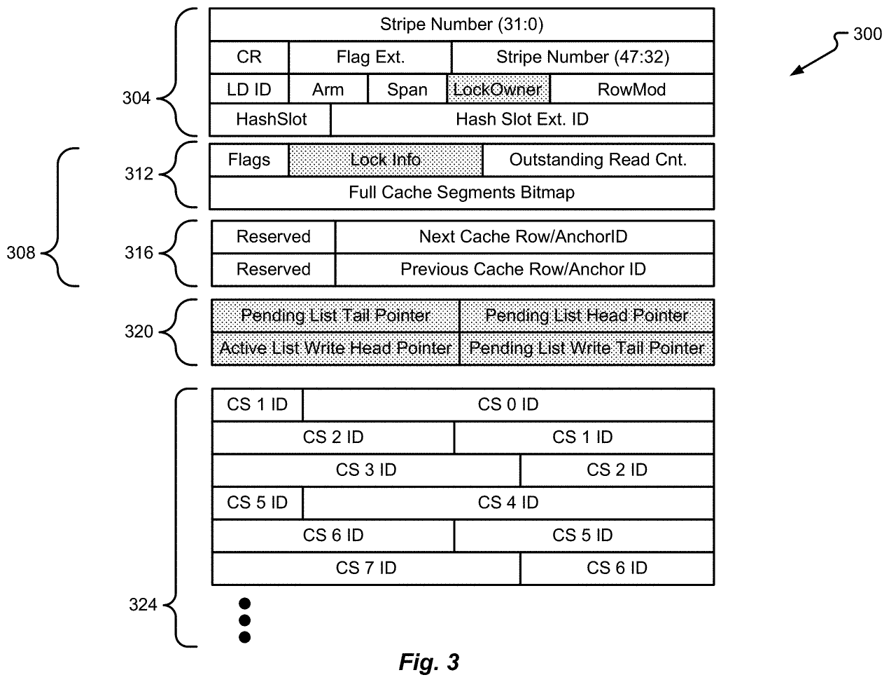

With reference now to FIG. 3, additional details of a first data structure 300 will be described in accordance with at least some embodiments of the present disclosure. The first data structure 300 may be used to store cache row frame metadata. As a non-limiting example, the first data structure 300 may correspond to part or all of a cache frame anchor 228. Although FIG. 3 shows the data structure 300 as having a particular layout/organizational structure, it should be appreciated that the data structure 300 may be configured in any number of ways without departing from the scope of the present disclosure. The data structure 300 may correspond to a data structure that is created and managed by the cache manager 252 or other components in memory 208.

The data structure 300 is shown to include a hash section 304 as well as a dirty list section 308 that includes first and second sub-sections 312, 316, respectively. The data structure 300 is also shown to include a row lock wait list section 320 and a strips section 324. The various sections of the data structure 300 may be used to store data that enables the controller 208 to utilize variable stripe sizes, thereby taking advantage of different workloads (where different types of commands require different amounts of memory and processing capabilities). In some embodiments, the cache manager 252 shouldn't need to worry about strip sizes, but it would be desirable to enable the cache manager 252 to effectively and efficiently respond to different types of commands (e.g., read or write commands) in an appropriate way.

In some embodiments, the hash section 304 includes a number of fields usable in connection with hash searches and other data lookup routines. As a non-limiting example, the hash section 304 may include a strip/stripe number field, a CR field, a flags extension field, a Logical Disk (LD) ID field, an Arm field, a Span field, a LockOwner field, a RowMod field, a hash slot field and a hash slot extension ID field.

The strip/stripe number field may store data that identifies the strip/stripe for which the data structure 300 is being used. In some embodiments, the strip/stripe field may uniquely identify a strip or stripe. In some embodiments, the strip/stripe field may identify a memory location (e.g., a starting location) of a strip or stripe of data stored in a storage device 136. For instance, the strip/stripe field may store a number that has been assigned to a particular strip or stripe of data.

The flag extension field may store information describing a memory location of a flag or an identifier of a flag associated with the data structure 300. Various types of flags may be used to identify a type of data stored in connection with the data structure 300 and the flag extension field may be used to identify that type of data.

The LD ID field may contain an identifier or multiple identifiers of logical disks used to store the data. The logical disk may be identified by a memory location or by some alias used in a naming scheme for the logical disks being managed by the controller 108.

The arm field may store a current value of a logical arm parameter. The Span field may store a value describing the span number in the Raid Volume (In case of single span the value is 0). The LockOwner field may include information describing a row lock, an owner of a row lock, a reason for the row lock, and any other information related to a row lock. The hash slot field and the hash slot extension ID field may contain data describing or uniquely identifying a cache row and/or hash slot extension.

The dirty list section 308 is shown to include a first sub-section 312 and a second sub-section 316. The first sub-section of the dirty list section 308 includes a flags field, a lock information field, an outstanding read count field, and a full cache segments bitmap. The second sub-section 316 is shown to include a next cache row/anchor ID field and a previous cache row/anchor ID field along with one or more additional reserved fields.

The flags field in the dirty list section 308 may contain an identifier of one or more flags associated with the dirty list identified by the data structure 300. The lock information field may contain information identifying whether a particular cache segment or row is locked or not, whether a particular cache segment or row is locked for a flush, and/or whether or not a particular cache segment or row is locked for a flush and a read operation.

The outstanding read count field may contain information describing how many and which cache segments or rows are waiting for a read. Conversely, this particular field may contain information describing a number of outstanding reads that have occurred. The cache segment bitmap may include a link to a bitmap stored in local controller memory or may actually correspond to a bitmap identifying a number and location of valid cache segments for the logical arms associated with the data structure 300.

The second sub-section 316 of the dirty list section 308 may contain information that describes a cache segment in the dirty list LRU. The information contained in this first sub-section 316 may include a number of reserved data fields, a next cache row/anchor identifier field, and a previous cache row/anchor identifier field. The next cache row/anchor identifier field and previous cache row/anchor identifier field may be used to create a linked listof cache segments. This linked list may be used in connection with performing any other operation performable by the controller 108. In some embodiments, the next cache row/anchor identifier field and previous cache row/anchor identifier field may be used to track a balance of a tree/chain structure. The data structure 300 may organize data based on LBA and based on a tree structure. As buffer segments are needed to accommodate the need for more buffer memory 220, the data structure 300 may be updated to reflect the addition of buffer segments to the tree/chain. These cache row/anchor identifier fields may store information that links specific cache segment IDs to one another in this tree/chain structure, thereby facilitating the creation of variable stripe sizes. As the names suggest, the next cache row/anchor identifier may contain information that identifies a next cache row or anchor in a chain of cache rows (relative to a currently allocated cache row) whereas the previous cache row/anchor identifier field may contain information that identifies a previous cache row/anchor in a chain of cache row (relative to the currently allocate cache rows). As additional cache rows are added to the tree/chain, the fields may both be updated to continue tracking the progressive building of the cache segment chain.

The row lock wait list section 320 may include a list of pointers that are used to create lists such as (i) an active wait list and (ii) a pending wait list. The active list may only have a head pointer whereas the pending list is provided with a head and two kinds of tails. Descriptions and locations of these heads and tails for the lists may be maintained within the section 320. In the depicted embodiment, the row lock wait list section 320 includes a pending list tail pointer, a pending list head pointer, an active list write head pointer, and a pending list write tail pointer. The pending list tail pointer may correspond to a field used to represent a tail of the pending list when the Cache Segment (CS)/Row is not part of dirty list. In some embodiments, this is where the read requests get added. The pending list head pointer may correspond to a field used to represent a head of the pending list when the CS/Row is not part of dirty list. This is where the first element of the pending list is accessed. The pending list write tail pointer may correspond to a field used to represent a write pending list when the CS/Row is not part of dirty list. This is where the write requests get added. The active list write head pointer may correspond to a field used to represent the head of the active command list. This list contains all the commands for which a write operation is in progress. It should be noted that when the row lock wait list section 320 is overloaded it can be used as a dirty list based on whether a row lock is active or not. If the lock information field has a predetermined value indicating that there is no current lock, then this field 320 can be interpreted as a dirty list rather than a wait list.

These pointers may actually point to a memory location in the controller or in buffer memory. Alternatively or additionally, the pointers may contain links to appropriate memory locations. These may contain numbers which refer to a particular memory location. As a non-limiting example: ID X may represent a memory location such as Base Address+X*(Size of Element).

The extents or strips section 324 is shown to include a plurality of extent frames and corresponding cache segment extents. In some embodiments, the extents may store 2 nibbles of data that describe information contained within the section 324. The nibbles in this section 324 represent the extent number of the extent stored in an extent frame. For 1 MB Cache data, there can be max 17 extents (each extent represents 64K data) out of which 1 extent is part of anchor frame and hence extent section represents remaining 16 extents. For example, anchor frame may have extent 5. Extent frame ID0 may have extents 01 and 02. Extent frame ID1 may have extents 00 and 04. Extent frame ID2 may have extents 05 and 06. Extent frame ID3 may have extents 16 and 12 and so on. The extents themselves don't need to be consecutive. By providing the extent frames consecutively in memory (although not a requirement), the extents in the extents section 320 can be scaled to store up to 1 MB of data in total (or more). In some embodiments, each extent can represent up to 64 kB of data. Hence, for a stripe size of 64 kB only one extent that fits in the data structure 300 is needed. For a 1 MB stripe size, sixteen extents would be needed (if each extent represents 64 kB of data), which means that a total of seventeen cache frame anchors would be needed (including the metadata). Although eight extents and extent frames are depicted, it should be appreciated that a greater or lesser number of extents and extent frames can be used without departing from the scope of the present disclosure. By enabling the chaining of multiple extents, variable stripe sizes can be accommodated. In some embodiments, not all extents or extent frames are allocated upon creation of the data structure 300. Instead, extents and extent frames can be allocated on an as-needed basis (e.g., in response to different commands, like a read-ahead command). As can be appreciated, data stored in the data structure 300 may be cleared when the corresponding data is committed to a storage media (e.g., a storage device 136).

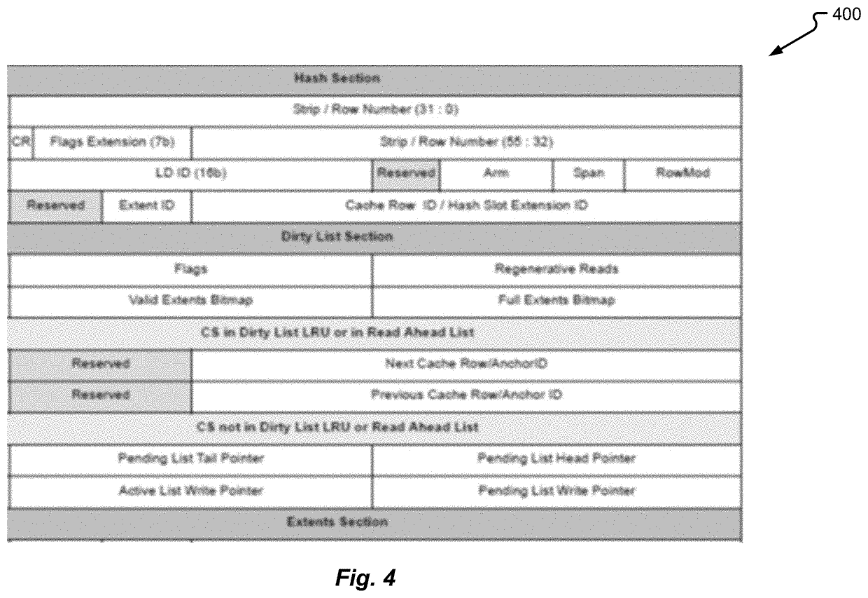

With reference now to FIG. 4, a second data structure 400 will be described in accordance with at least some embodiments of the present disclosure. The second data structure 400 may be used to store CS metadata, in some embodiments. Specifically, the data structure 400 may include a number of data fields that are similar or identical to the data fields found in data structure 300. One difference between the data structures 300/400, is that the second data structure 400 may contain strip or row numbers rather than stripe numbers. The second data structure 400 may also include an extent ID field and cache row ID/hash slot extension ID field rather than a simple hash slot extension ID field from data structure 300.

Further still, the data structure 400 may include a dirty list section. Within the dirty list section, the data structure 400 may include a CS in dirty list LRU or in read ahead list section and a CS not in dirty list LRU or read ahead list section. Finally, the data structure 400 is shown to include an extents section. As the name suggests, the extents section may include a listing of CS extents and identifiers associated therewith. The dirty list section contains information similar to dirty list section 308, such as flags, next cache row/anchor ID fields, previous cache/row anchor ID fields, and fields used to identify beginnings and ends of active read ahead lists and pending lists.

The dirty list section of the data structure 400, different from data structure 300, is further shown to include a regenerative reads field, a valid extents bitmap, and a full extents bitmap. The regenerative reads field may include a counter value that tracks a number of regenerative reads performed on a particular strip or row. The valid extents bitmap may include a bitmap or similar set of information that identifies extents within the extents section that are valid and the full extents bitmap may identify extents that are fully utilized.

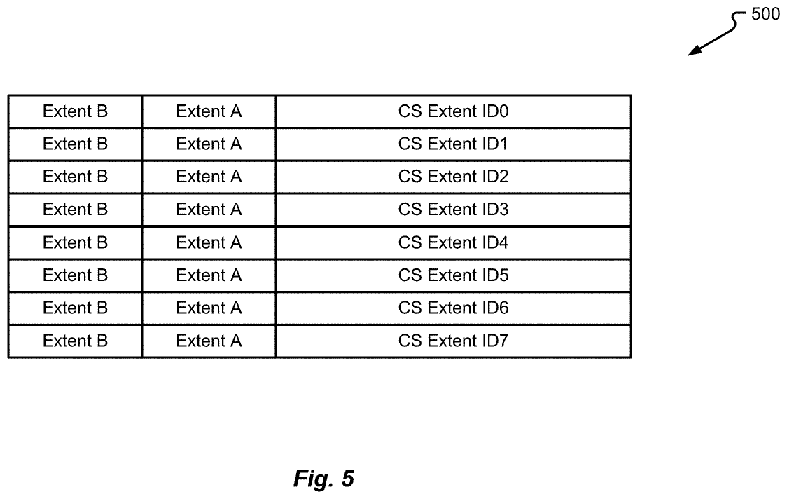

FIG. 5 depicts additional details of a data structure 500 that may correspond to an extents section of the data structure 400. Specifically, the extents section 500 is shown to include a first extent and second extent identifier column along with an associated CS extent field. Each CS extent field ID0-ID7 may correspond to an identifier of a different CS extent. Although FIG. 5 depicts a particular configuration of the extents section 500, which may be included as part of the extents section of the data structure 400, it should be appreciated that any format of data fields containing some or all of the information depicted in FIG. 5 may be used as part of the extents section in the data structure 400.

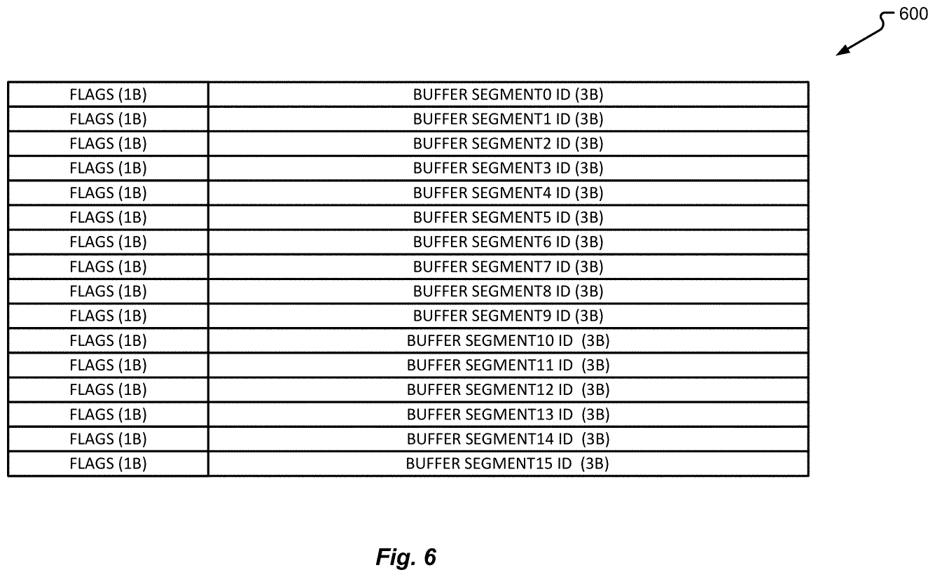

FIG. 6 depicts yet another data structure 600 that may be used in accordance with at least some embodiments of the present disclosure. The data structure 600 may correspond to a CS buffer extent section. The buffer extent section is shown to include a plurality of flag fields and associated buffer segment (BS) ID fields. In some embodiments, the data structure 600 includes sixteen (16) BS ID fields and corresponding flag fields. Each BS ID field may be approximately 3 bytes whereas a flag field may only consume a single byte. It should be appreciated that any size of data field can be used for the flags and/or BS ID fields. Additionally, although FIG. 6 depicts the data structure 600 as having sixteen BS ID fields, a greater or lesser number of BS ID fields can be used without departing from the scope of the present disclosure.

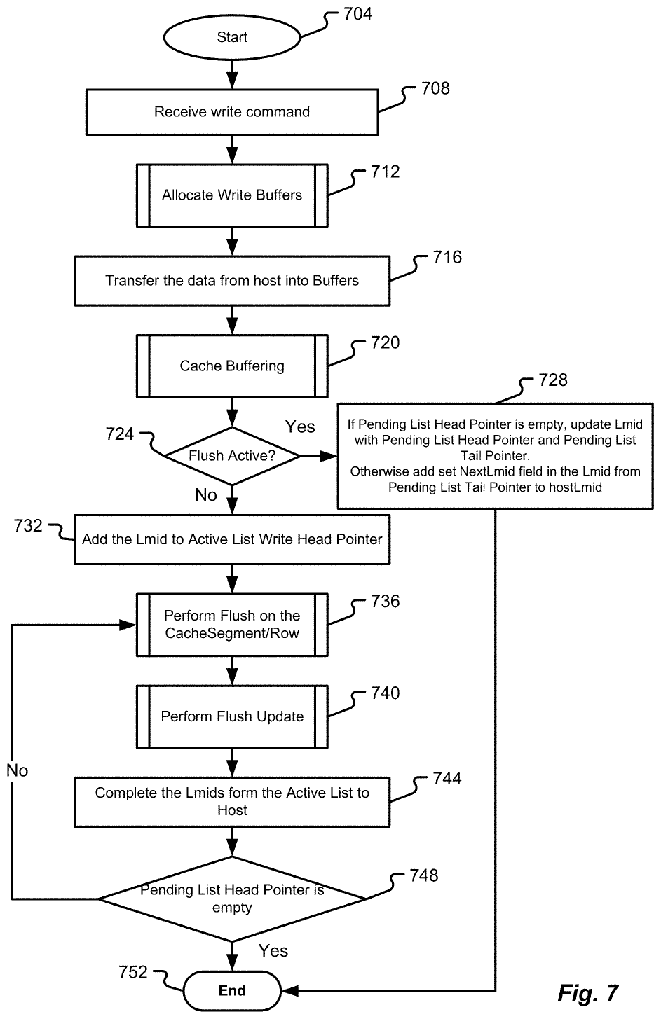

FIGS. 7-13 depict a number of methods and steps of achieve those methods. Each method will be described in accordance with at least some embodiments of the present disclosure. It should be appreciated that some or all of the methods shown in FIGS. 7-13 may be performed partially or wholly within the controller 108 or components thereof. While reference may be made to certain components of the controller 108 performing certain steps of methods, embodiments of the present disclosure are not so limited. Rather, it should be appreciated that any component of any controller 108 (or similar device) may be configured to perform some or all of the steps depicted and described herein.

With reference now to FIG. 7, a method of performing a write through write command processing method will be described in accordance with at least some embodiments of the present disclosure. The method begins with a start operation (step 704) and proceeds when a write command is received at the controller 108 (step 708). The write command causes the host interface manager 232 to invoke the buffer manager 248. In particular, the buffer manager 248 may be invoked to allocate one or more write buffers (step 712). In some embodiments, the buffers are allocated from buffer memory 220.

The method continues with the buffer manager 248 invoking the DMA engine 264 to transfer the data received from the host in the write command into the allocated buffers (step 716). The method then continues by invoking the cache buffering routine 268 (step 720), which starts by determining if a flush is currently active within the controller cache 140 or, more particularly, within cache memory (step 724). If the query of step 724 is answered positively, then the cache manager 252 will continue to step 728. In step 728, the cache manager 252 may determine if the pending list head pointer is empty (within either data structure 300 or 400 depending upon the size of the write request). If the pending list head pointer is empty, then the cache manager 252 will update the pending list head pointer and pending list tail pointer with the hostLMID. Otherwise, the cache manager 252 will set the nextLmid field in the Lmid that is present in pending list tail pointer to the hostLMID and nextLmid field in the hostLMID is set to NULL, to indicate that this is the last Lmid in the list. Then the pending list tail pointer is updated with hostLmid. This effectively updates the LMID (e.g., internal controller 108 command) for use by other components within the controller 108. After step 728 is completed, the method ends (step 752).

Referring back to step 724, if the flush is not active, then the cache manager 252 will add the hostLMID to the active list write head pointer (step 732). Thereafter, the flush processor 272 may be invoked to perform a flush on the cache segment or row (step 736). The method will then continue by performing a Cache update (step 740). Then the LMIDs from the active list are completed to the host (step 744). The cache manager 252 will then determine if the pending list head pointer has reached an empty field (step 748). If not, the method returns to step 736. If so, the cache manager 252 can determine that the active list is completed and complete the method at step 752.

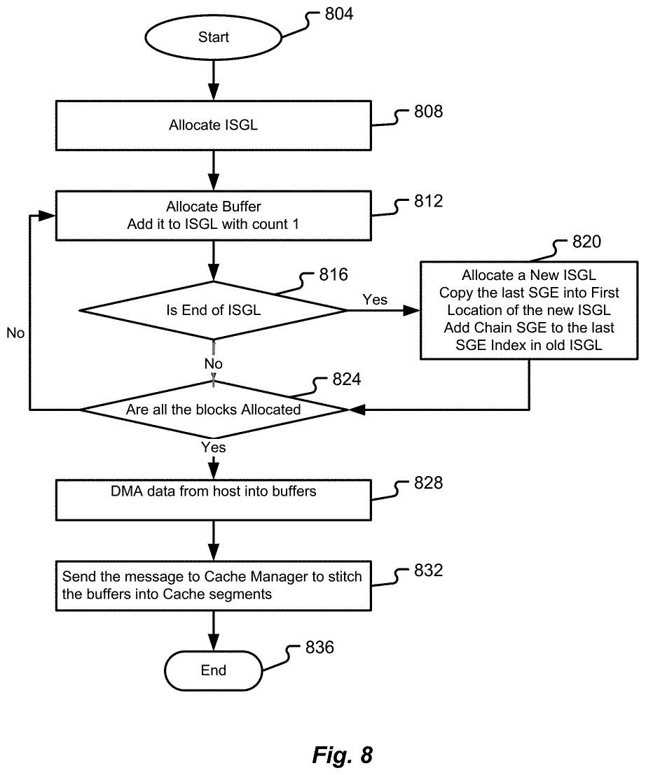

With reference now to FIG. 8, a method of allocating write buffers will be described in accordance with at least some embodiments of the present disclosure. Details of this method may be used to perform step 712 as discussed in connection with FIG. 7.

The method begins with a start operation (step 804) and then proceeds with the allocation of one or more ISGLs (step 808). The buffer manager 248 may then allocate a buffer from the buffer memory 220 and add the newly-allocated buffer to the ISGL with a count of ‘1’. (step 812). The buffer manager 248 may then determine if it has reached the end of the ISGL (step 816). If the query of step 816 is answered affirmatively, the buffer manager 248 may allocate another new ISGL and copy the last SGE into the first location of the newly-allocated ISGL (step 820). This effectively adds a chain of SGEs to the last SGE index in the previous ISGL.

Thereafter, or if the query of step 816 is answered negatively, the method proceeds with the buffer manager 248 determining whether all of the blocks from the write command have been sufficiently allocated to a buffer (step 824). If not, the method returns to step 812. If so, the method continues with the buffer manager 248 invoking the DMA engine 264 to DMA the data from the host (e.g., the data from the write command(s)) into the allocated buffers (step 828). Once all blocks of data have been placed into a buffer, the method continues with the buffer manager 248 messaging the cache manager 252 to begin processing the write command (step 832). In some embodiments, the cache manager 252 may receive an LMID from the buffer manager 248 indicating that the cache manager 252 is to stitch the newly-allocated buffer(s) into cache segments. Thereafter, the method ends (step 836).

The write request processing on a RAID 5/6 write back volume, in some embodiments, involves allocating buffers and stitching them into cache memory 148 and completing the command to the host. In some embodiments, the data would remain in the cache 148 for certain amount of time until it is flushed to the backend devices 136a-N. Whereas on a write through volume after buffers are allocated and stitched into cache, the data needs to be flushed immediately onto the backend devices and the host command can be completed only after the flush is completed.

On a RAID 5/6 volume, the flush operation is limited to a row since update to parity is involved. Hence, if the host write request spans more than one row, the write request may be split into multiple child commands such that one command is issued per row. Splitting the host command into child commands may be done within the command extraction unit 240. Once all the child commands are completed then the host command is completed.

While the trigger for flush on a row on a write back and write through volume is different on a write back and write through volume, the flush operation in general would follow the same method. Hence the method for write through I/O processing should be such that input to the flush routing 272, 280 is provided in the same way as that of a write back volume.

The host request or the child request may be sent to buffer manager 248. The manager 248, as discussed above, may be configured to allocate ISGLs, and buffer segments, and populate the buffer segments into ISGL. The number of buffers that are allocated would be based on the number of blocks in the write request. The ISGL is updated into the write request and the write request is forwarded to DMA engine 264.

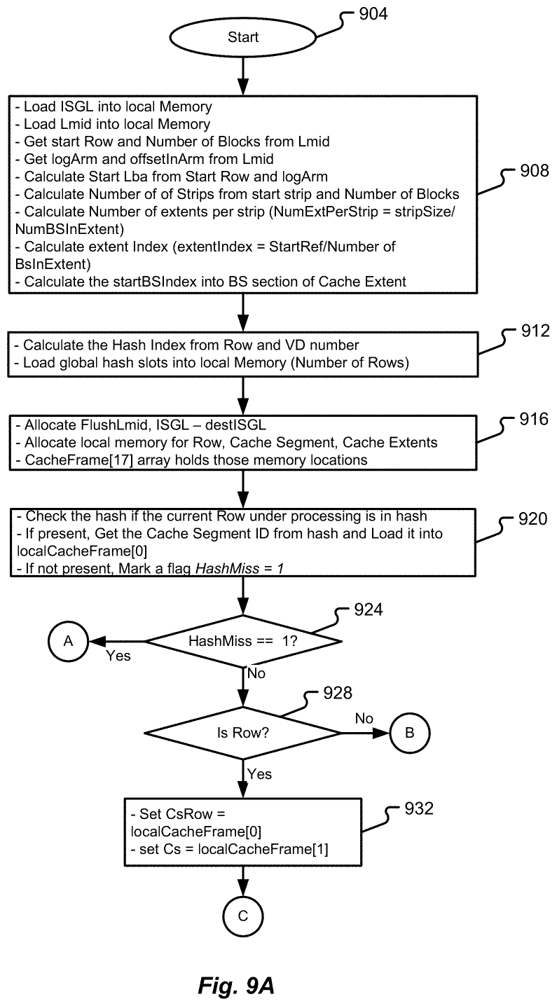

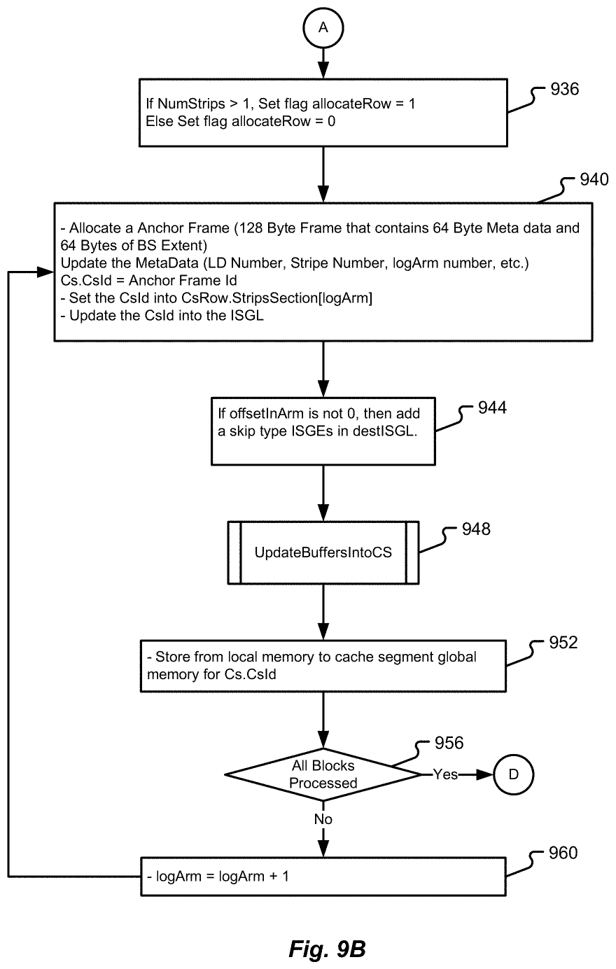

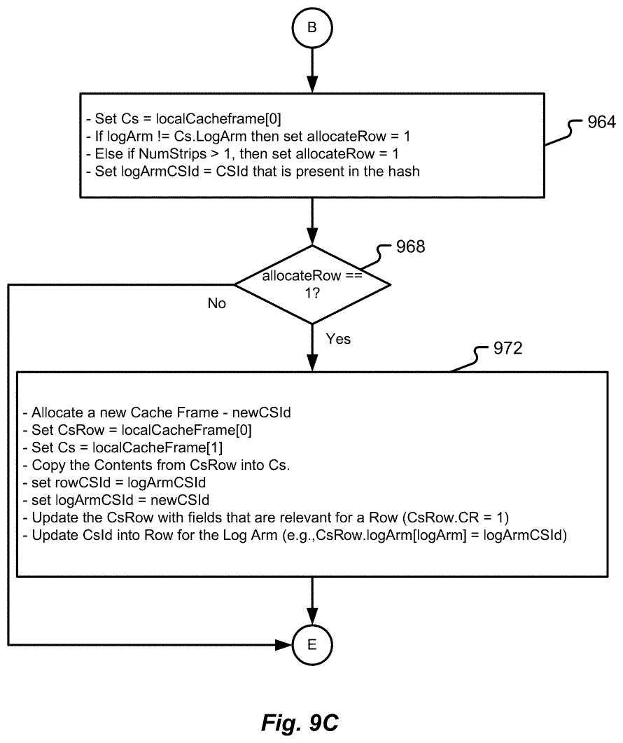

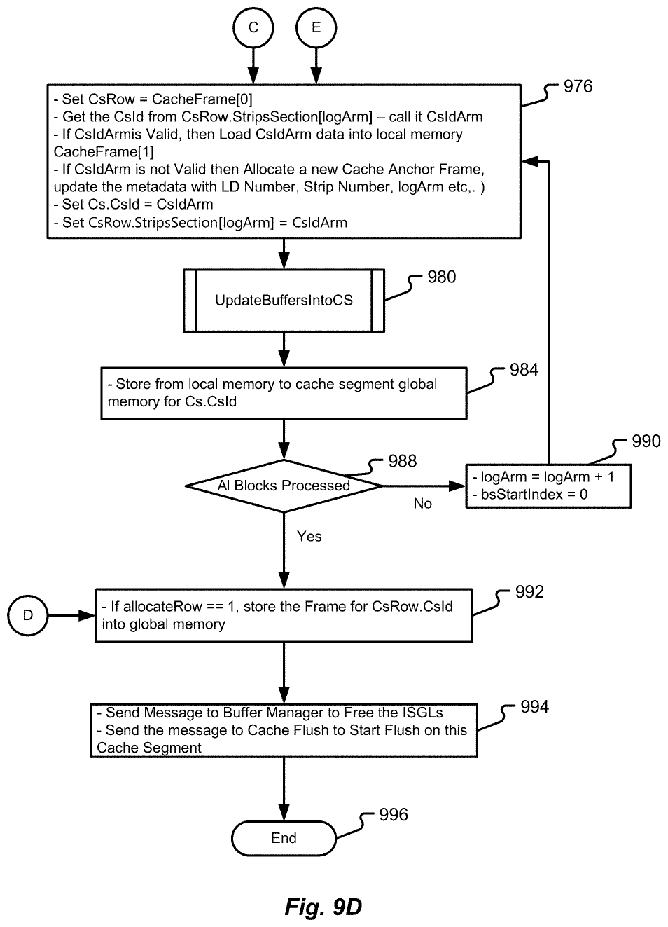

With reference now to FIGS. 9A-D, a method of performing a RAID 5/6 write through cache buffering process will be described in accordance with at least some embodiments of the present disclosure. As shown in FIG. 9A, the method begins with a start operation (step 904) and continues with the cache buffering routine 268 performing a number of tasks to begin allocation of a new ISGL (e.g., referred to as a “destIsgL” in FIG. 9A-D) (step 908). As part of this step, the cache buffering routine 268 may also load an LMID into location memory, get a start row and number of blocks from the LMID, get the logArm and offsetInArm from the LMID, and then calculate a start LBA from the start row and logArm. The cache buffering routine 268 may further calculate a number of strips from the start strip and the number of blocks, then calculate a number of extents per strip. Further still, the cache buffering routine 268 may calculate the extent index and then calculate the startBSIndex into the BS section of the cache extent.

The method will then continue with the cache buffering routine 268 calculating a hash index from the row and virtual disk (VD) number and then loading the globlal hash slots into local memory of the controller 108 (step 912).

The cache buffering routine 268 then allocates a flush LMID and populates it with the ISGL IDs and offset for each of the logArm, while also stitching the buffers (step 916). In this step, the cache buffering routine 268 may also update the parent LMID field in the flush LMID with the LMID ID of the write request. In some embodiments, the CS row pointer and/or CS pointer may be set to point to a local cache frame and the CS ID for the strip and/or row may be set to INVALID.

In some embodiments, the cache buffering routine 268 then checks the hash if the current row under processing is in the hash (step 920). If present, the CS ID is obtained from the hash and loaded into a local cache frame. Otherwise, the flag will be marked as a hash miss=1.

Thereafter, the method continues by checking if there is a hash hit or hash miss (step 924). If it is the first I/O, then it will be hash miss and the method proceeds to step 936 as shown in FIG. 9B. Thus, for the first I/O case, there will likely be a hash miss at step 924). The cache buffering routine 268 will continue by checking if the I/O spans more than one strip (step 936). If the I/O spans more than one strip, then a row is required in addition to one cache segment for each strip, accordingly set the flag allocateRow=1. The cache buffering routine 268 may further allocate a cache frame in this step and set the rowCSId to the frame ID that is allocated. Additionally, the cache buffering routine 268 may set a flag updateHash=1 and then zero out the 128 bytes in cache segment row pointer memory.

If the I/O spans only one strip, then just one cache segment is sufficient and in this case the CSId of the cache segment can be updated into hash. As an example, the allocateRow is set equal to 0 in this case.

The method then continues with the cache buffering routine 268 allocating a cache segment frame (e.g., a 128 byte frame that contains 64 bytes of metadata and 64 bytes of BS Extent) (step 940). In this step, the cache buffering routine 268 may also set logArmCSId to the Frame Id that is allocated and then update the metadata (e.g., LD Number, Stripe Number, logArm number, etc.). Further still, the CsId may be set into CsRow.Ptr.StripsSection[logArm]. In some embodiments, the CsRow may be in local controller 108 memory. This would be updated into global memory later only if allocateRow flag indicates accordingly (e.g., with a value of ‘1’). The CsId may then be updated into the ISGL.ISGE[currentIndex]

Update in the FlushLmid.SGLId[arm]=destlsgl and FlushLmidSGLOffset[logArm]=destISGL Index. In some embodiments, if offsetInArm is not 0, then a skip type ISGE may be added into the destISGL (step 944). The number of skips to be added may depend on the size of the buffers in the RAID manager 256 that is used during flush. If the size of the RAID manager buffer is 64K (e.g., 16 4K buffers), and offsetInArm is 18, then 2 skips might be added. If it is the first strip of the I/O request, then the cache buffering routine 268 may set bsStartIndex=offsetInArm, otherwise set bsStartIndex=0.

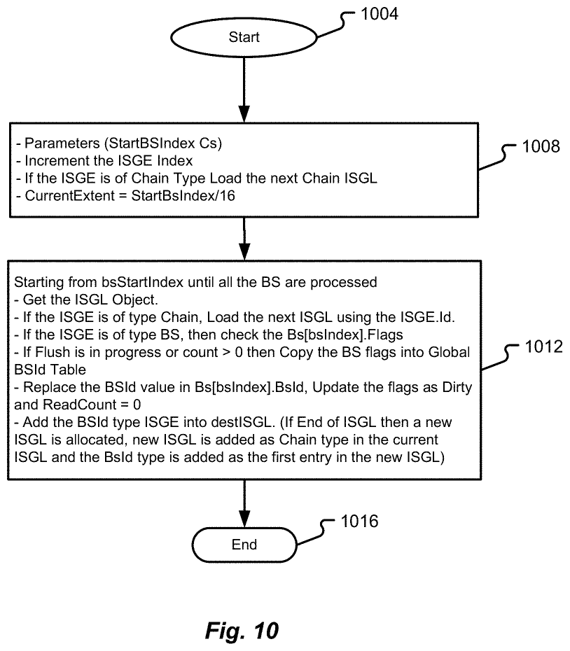

The next step may be to populate the buffer segment IDs from the ISGL into the cache segment buffer section and destISGL (step 948). Additional details related to how buffer segment IDs can be populated from an ISGL into the cache segment buffer section and destISGL are described in connection with FIG. 10.

After the buffer has been updated into the cache segment as a cache segment buffer section, the method continues by storing the logArmCSId into global cache memory (step 952). In some embodiments, the buffer manager 248 and/or cache manager 252 may copy 128 bytes from a cache segment local memory into global memory.

The cache buffering routine 268 will then check if all the blocks for the write request are processed (step 956). If not, the cache buffering routine 268 will move to the next arm (e.g., increment an arm as logArm=logArm+1 (step 960). The cache buffering routine 268 then returns back to step 940 to process the next arm.

If, however, all blocks are processed, then the method proceeds to step 992 (FIG. 9D) where the allocateRow value is checked. If the allocateRow value equals a predetermined value (e.g., a value of ‘1’), then the frame for the cache segment row is stored into global memory. At this point, the write through process is completed and a message is transmitted to the buffer manager 248 instructing the buffer manager 248 to free the previously-allocated ISGL(s) (step 944). This step may further include sending an appropriate message to the cache flush processor 272 to start the flush on the cache segment that was being processed. Thereafter, the method ends (step 996).

Referring back to step 924, while a flush is in progress on the row, if a new write request is received on the same row, the allocation of buffers is done in the same way as described above and the cache buffering routine 268 would process it in the same fashion. In this case, however, the cache buffering routine 268 discovers that it is a hash hit. Upon making this determination at step 924, the cache buffering routine 268 obtains the CSID that is present in the hash and loads the CSID into local cache frame memory. Next, the cache buffering routine 268 checks the localCacheFrame[0] CR field (step 928). If the value of this field is a particular predetermined value (e.g., a value of ‘1’), then the cache buffering routine 268 understand that the CsId corresponds to a row (e.g., the query is answered positively) and if the field is a different predefined value (e.g., a value of ‘0’), then it corresponds to a cache segment for one of the logical Arm/strip (e.g., the query is answered negatively).

If the cache buffering routine 268 determines that the query of step 928 is answered negatively, then set Cs.Ptr=localCacheFrame[0] (step 964). This particular step may also include a sub-routine of checking if logarm==Cs.logArm. If not, then set the flag allocateRow=1. Set logArmCSId=CSId. On the other hand, if the CR field indicates that it is not a Row and Number of strips spanned by the current write request is more than 1 then also set the flag allocateRow=1.

Depending upon the value of the allocateRow field (step 968), the cache buffering routine 268 will either allocate a new cache frame or not. If in the above steps allocateRow was set to 1 then a row needs to be allocated (step 972). For a RAID 5/6 volume, if the row exists then it is desirable to have the row CSID in the hash. But since the CSID for the cache segment already exists in the hash, the logArmCSId would need to be re-purposed for the row. So effectively after this step, the CSID that is present in the hash will be used for the row and a new cache frame is allocated which would be used for the logArmCSId. This can be achieved by performing the following:
Allocate a new Cache Frame—newCSId
Set CsRow.Ptr=localCacheFrame[0]
Set Cs.Ptr=localCacheFrame[1]
Copy the Contents from CsRow.Ptr into Cs.Ptr.
set rowCSId=logArmCSId
set logArmCSId=newCSId
Update the CsRow with fields that are relevant for a Row (CsRow.CR=1)
Update CsId into Row for the Log Arm ie. CsRow.logArm[logArm]=logArmCSId

The method then proceeds with the cache buffering routine 268 checking to see if the startLogArm for the write request is same as the Cs.logArm. If so, then a new cache segment need not be allocated for this strip and update the cache segments that corresponds to the CSID. This can be repeated to stitch the buffers into the cache segment.

Referring back to step 928, if the check indicates that the CSID corresponds to a row, then the cache buffering routine 268 sets CsRow=localCacheFrame[0] and Cs=localCacheFrame[1] (step 932).

Thereafter, or following the processing from steps 968 and 972, the cache buffering routine 268 will get the CSID from CsRow.StripsSection[logArm] and call it logArmCSID (step 976). The cache buffering routine 268 may also update the buffers into the cache segment (step 980) and load the logArmCSID data into local memory (e.g., in this case localCacheFrame[1]) (step 984). As part of step 976, if CSIdArm is not valid then a cache segment may be allocated and buffers may be stitched.

If all blocks are not processed as determined in step 988, then the cache buffering routine 268 increments logArm (e.g., by setting logArm=logArm+1) (step 990), then returns back to step 976. This loop will then be repeated until all blocks are processed.

If all blocks are processed then, then the method proceeds to step 992 to check if allocateRow==1. If so, then Store the CsRow into global memory (step 994) and then the method ends (step 996).

At this point of time, the flush LMID may look the same way as it would be for a write back volume for performing a flush on a row. The flush LMID may then be forwarded to flush processor 272, which may be part of the RAID manager 256.

With reference now to FIG. 10, additional details of updating buffers into a cache segment will be described in accordance with at least some embodiments of the present disclosure. This method may correspond to some or all of the sub-routines performed as part of step 948. The method begins with a start operation (step 1004) and continues by populating the buffer segment IDs from the ISGL into the cache segment buffer section and destISGL.

Starting from bsStartIndex, the following steps may be performed until all the blocks in the strip are processed (step 1012).
Get the next ISGL Object.
If the ISGE is of type chain, load the next ISGL using the ISGE.Id.
If the ISGE is of type buffer segment (BS), then check the Bs[bsIndex].Flags
If flush is in progress or Readcount>0 then copy the BS flags into Global BSID Table
Replace the BSID value in Cs.Ptr.Bs[bsIndex].BsId, Update the flags as Dirty and ReadCount=0
Add the BSId type ISGE into destISGL. (If End of ISGL then a new ISGL is allocated, new ISGL is added as Chain type in the current ISGL and the BsId type is added as the first entry in the new ISGL)

Once all of the blocks in the strip have been processed, the method ends (step 1016).

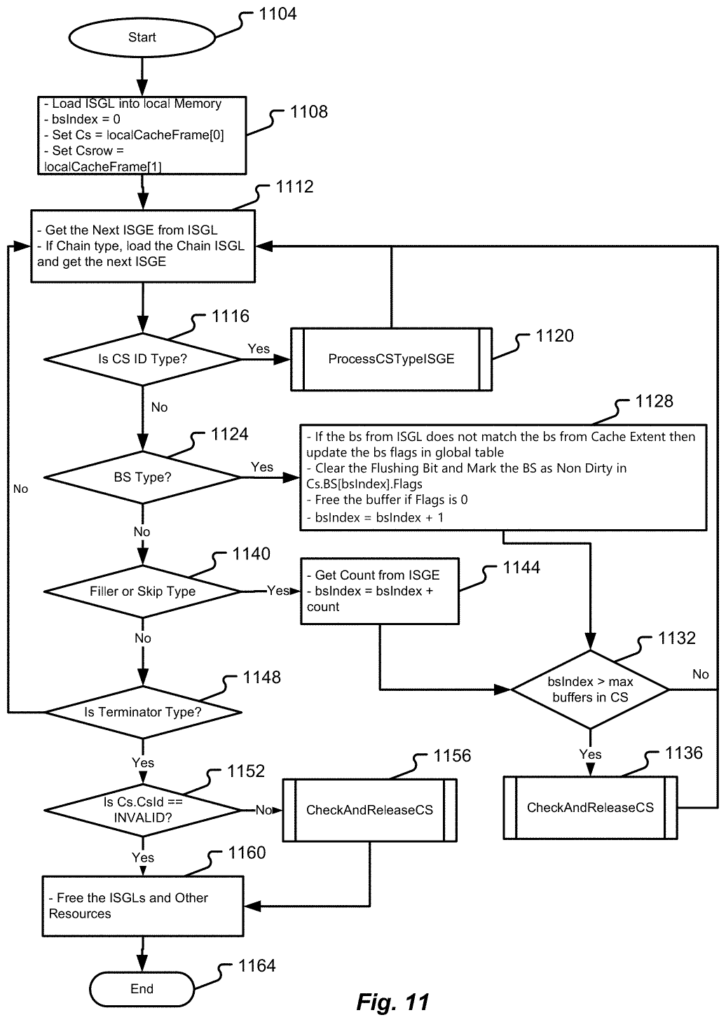

With reference now to FIG. 11, a method of performing a cache update will be described in accordance with at least some embodiments of the present disclosure. The method begins with a start operation (step 1104) and continues with the cache update routine 276 loading the ISGL into local memory and initializing the bsIndex (step 1108). In this step, the cache update routine 276 may also set the cache segment pointer, cache row pointer, and cache segment ID (CSID) as follows: Set Cs.Ptr=localCacheFrame[0], Csrow.Ptr=localCacheFrame[1], Cs.CsId=INVALID, CsRow.CsId=INVALID.

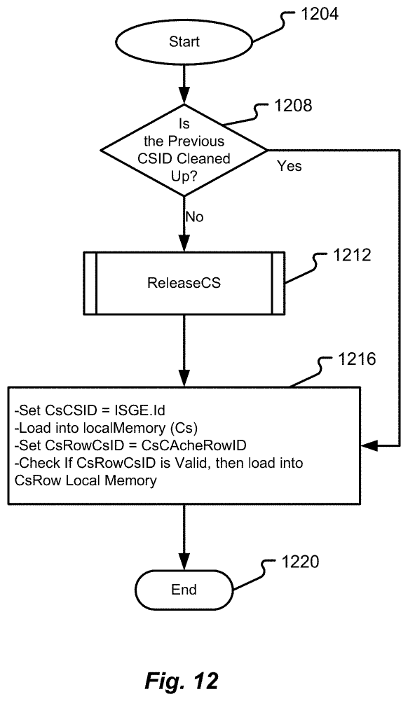

The ISGL is then parsed and each ISGE from the ISGL is processed based on its type (step 1112). If the SGE is of type CS (step 1116), the cache update routine 276 will process the CS type ISGE (step 1120) and then the method returns to step 1112 for the next ISGE. Additional details of processing a CS type ISGE are depicted and described in connection with FIG. 12.

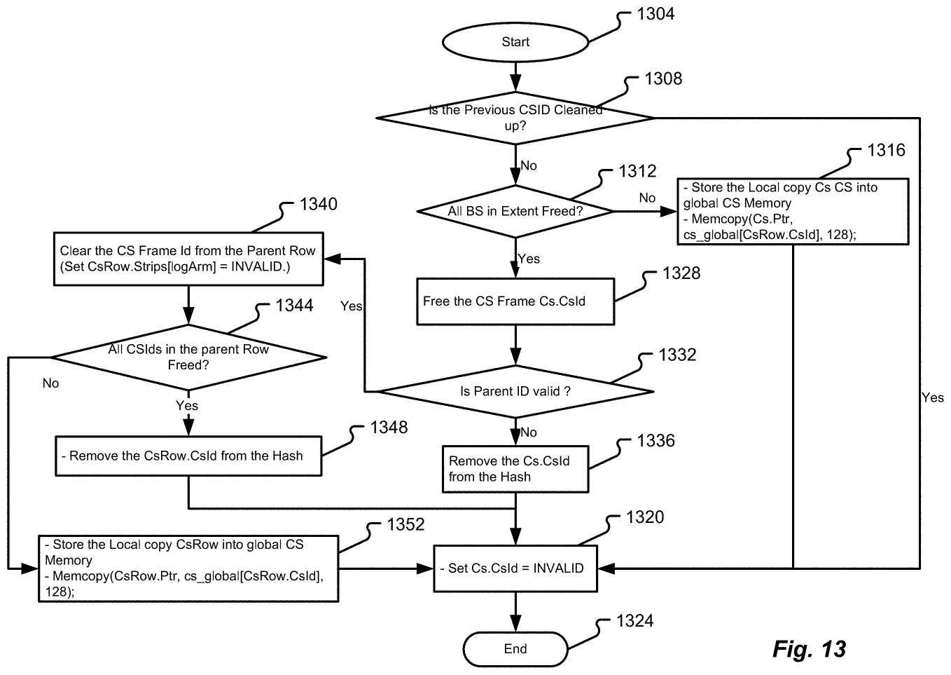

If the previous CS is not cleaned up (e.g., Cs.CsId !=INVALID), then the cache update routine 276 may perform the following: (1) Set Cs.CsId=ISGE.Id; (2) Load the cache segment into localMemory (Cs); (3) Set CsRow.CsId=Cs.Ptr.CacheRowID; and (4) Check If CsRow.CsId is valid then load it into CsRow.Ptr local memory. If Cs.CsId is Valid (e.g., the previous CS is not cleaned up), the cache update routine 276 may perform a check and release routine on the cache segment as depicted and described in connection with FIG. 13.

If the query of step 1116 is answered negatively, then the cache update routine 276 may check to see if the ISGE is of the BS type (step 1124). If the buffer segment from the ISGL does not match the buffer segment from the cache extent, then the cache update routine 276 may update the bs flags in global bs table. The cache update routine 276 may clear the flushing bit and mark the BS as Non Dirty in Cs.BS[bsIndex].Flags (step 1128). The cache update routine 276 may further free the buffer if Flags=0. The cache update routine 276 may then increment bsIndex (e.g., by setting bsIndex=bsIndex+1). The cache update routine 276 may then check to see if the new value of the bsIndex is greater than a max number of buffers in the cache segment (step 1132). If not, the method returns to step 1112. If so, the method will continue to step 1136, which is shown in further detail in FIG. 13.

Referring back to step 1124, if the query is answered negatively, the method will continue with the cache update routine 276 determining if the ISGE is of skip type of filler type (step 1140). If this query is answered affirmatively, then the method continues with the cache update routine 276 getting the count from the ISGE.count and then incrementing the bsIndex by the count value (step 1144). It should be noted that the ISGE may contain a filler type in case the RAID manager 256 flush decides to use temporary buffers which are called fillers for performing the flush. In such embodiments, the RAID manager 256 may not clear those in the ISGL to avoid memory touches. Hence, for write through flush processing, those filler buffers are ignored and only the count would be used to increment the bsIndex. The method then continues to step 1132.

If the query of step 1140 was answered negatively, then the cache update routine 276 may continue by determining if the ISGE is of terminator type (step 1148). If not, the method returns back to step 1112. If so, then the method continues determining if the CsRow.CsID is not INVALID (step 1152). If this query is answered negatively, then the check and release of the CS is performed (step 1156). Specifically, if CsRow.CsId is not INVALID, then the local copy of CsRow may be stored into global cache segment memory. Thereafter, or in the event that the query of step 1152 was answered positively, the method continues by freeing the ISGLs and other resources (step 1160). As part of this process, the write requests may be completed in the active list to the host and then the method ends (step 1164).

If the wait list is not empty, then the wait list may be moved into the active list and another flush request may be issued to the cache flush processor 272. Once the cache flush is done, the cache update routine 276 may perform the clean up as described above. This process continues until the wait list is empty.

With reference now to FIG. 12, additional details of processing a CS type ISGE will be described in accordance with at least some embodiments of the present disclosure. The method begins with a start operation (step 1204) and continues with the cache update routine 276 determining if the previous CSID has been cleaned up (step 1208). If not, then the process of releasing the cache segment is performed (step 1212), which is described in further detail with reference to FIG. 13.

Thereafter, or if the query of step 1208 is answered affirmatively, the method then continues by setting the new value of the cache segment CSID to the ID from the ISGE, loading the cache segment into local memory, setting the CsRowCsID, and checking if the CsRowCsID is valid (step 1216). The method then ends at step 1220.

With reference now to FIG. 13, additional details of a method for checking and releasing the cache segment will be described in accordance with at least some embodiments of the present disclosure. The method starts with a start operation (step 1304) then continues by determining if the previous CSID has been cleaned up (step 1308). If this query is answered affirmatively, then the Cs.CsID is set to an INVALID value (step 1320) and the method ends (step 1324).

However, if the previous CSID has not been cleaned up, the method continues by determining whether or not all buffer segments in the extent have been freed (step 1312). If there is at least one buffer segment for which the flags is not 0 (e.g., a buffer segment remains unfreed), then this cache segment cannot be freed. Hence the updated cache segment is stored back to global cache memory. (step 1316).

If all buffer segments are freed, then the method continues by freeing the cache segment frame (step 1328) and then determining if the parent ID is valid (e.g., by checking if CsRow.CsId is valid.) (step 1332). If the parent ID is valid, then the method proceeds further by clearing the cache segment frame ID from the parent row (step 1340) and then checking to see if all CSIDs in the parent row have been freed (step 1344). If the query of step 1344 is answered negatively, then a local copy of the cache segment row is stored into the global cache segment memory (step 1352). Thereafter, the method proceeds to step 1320. If the query of step 1344 is answered positively, the method proceeds by removing the CSID for the cache segment row from the hash (step 1348) and then the method proceeds to step 1320.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method for processing Input/Output (I/O) requests, the method comprising:
receiving a first write request to a first row;
while processing the first write request, receiving a subsequent write request to the first row; and
caching the subsequent write request for processing until the first write request is completed.

2. The method of claim 1, further comprising:
while processing the first write requesting, receiving a read request to the first row; and
processing the read request in parallel with processing the first write request.

3. The method of claim 1, wherein the first write request is received from a first host and wherein the subsequent write request is received from a second host that is different from the first host.

4. The method of claim 1, further comprising:
coalescing all write requests received from a host until processing of the first write request is completed; and
after processing of the first write request is completed, enabling further processing of all write requests that were coalesced during processing of the first write request.

5. The method of claim 1, further comprising:
determining that the first write request has completed processing; and
after determining that the first write request has completed processing, enabling the subsequent write request to be processed.

6. The method of claim 1, further comprising:
while processing the first write request, receiving a second subsequent write request;
determining that the second subsequent write request is to a second row that is different from the first row; and
enabling the second subsequent write request to be processed in parallel with processing the first write request.

7. The method of claim 1, further comprising:
updating a parity drive in connection with processing the first write request.

8. The method of claim 1, further comprising:
allocating cache memory in response to receiving the first write request; and
utilizing the allocated cache memory in connection with caching the subsequent write request.

9. A memory control system, comprising:
a host interface that receives one or more host Input/Output (I/O) requests;
a storage interface that enables communication with a plurality of storage devices configured in a storage array;
a microprocessor; and
memory that includes computer-readable instructions that are executable by the microprocessor, the instructions enabling performance of a write through process and including:
instructions that receive a first write request to a first row;
instructions that, while processing the first write request, receive a subsequent write request to the first row; and
instructions that cache the subsequent write request for processing until the first write request is completed.

10. The memory control system of claim 9, wherein the instructions further include instructions that, while processing the first write requesting, receive a read request to the first row as well as instructions that process the read request in parallel with processing the first write request.

11. The memory control system of claim 9, wherein the first write request is received from a first host and wherein the subsequent write request is received from a second host that is different from the first host.

12. The memory control system of claim 9, wherein the instructions further include instructions that coalesce all write requests received from a host until processing of the first write request is completed after processing of the first write request is completed, enable further processing of all write requests that were coalesced during processing of the first write request.

13. The memory control system of claim 9, wherein the instructions further include instructions that determine that the first write request has completed processing and after determining that the first write request has completed processing, enable the subsequent write request to be processed.

14. The memory control system of claim 9, wherein the instructions further include instructions that, while processing the first write request, receive a second subsequent write request, determine that the second subsequent write request is to a second row that is different from the first row, and enable the second subsequent write request to be processed in parallel with processing the first write request.

15. The memory control system of claim 9, wherein the instructions further include instructions that update a parity drive in connection with processing the first write request.

16. The memory control system of claim 9, wherein the instructions further include instructions that allocate cache memory in response to receiving the first write request and utilize the allocated cache memory in connection with caching the subsequent write request.

17. A cache system, comprising:
cache memory; and
instructions that enable management of the cache memory to facilitate a write through to be performed, the instructions including:
instructions that receive a first write request to a first row;
instructions that, while processing the first write request, receive a subsequent write request to the first row; and
instructions that cache the subsequent write request for processing until the first write request is completed.

18. The cache system of claim 17, wherein the instructions further include instructions that, while processing the first write requesting, receive a read request to the first row as well as instructions that process the read request in parallel with processing the first write request.

19. The cache system of claim 17, wherein the instructions further include instructions that coalesce all write requests received from a host until processing of the first write request is completed after processing of the first write request is completed, enable further processing of all write requests that were coalesced during processing of the first write request.

20. The cache system of claim 17, wherein the instructions further include instructions that, while processing the first write request, receive a second subsequent write request, determine that the second subsequent write request is to a second row that is different from the first row, and enable the second subsequent write request to be processed in parallel with processing the first write request.
